(19) United States
(12) Patent Application Publication
(10) Pub. No.: US 2004/0110012 A1
(43) Pub. Date: Jun. 10, 2004

(54) Coating composition and a process for its preparation

(76) Inventors: Peter Bier, Krefeld (DE); Peter Capellen, Krefeld (DE)

Correspondence Address: BAYER POLYMERS LLC, 100 BAYER ROAD, PITTSBURGH, PA, 15205, US

(21) Appl. No.: 10/673,903

(22) Filed: Sep. 29, 2003

(30) Foreign Application Priority Data
Oct. 1, 2002 (DE) 10245729.8

(51) Int. Cl. B05D 3/08; B05D 3/02

(52) U.S. Cl. 428/422.8; 106/287.11; 106/287.13; 106/287.14; 106/287.17; 106/287.19; 106/287.18; 106/287.16; 427/376.1; 427/533; 427/224

(57) ABSTRACT

A process or preparing a coating composition which involves forming a hydrolysis product is described. The hydrolysis product is formed by hydrolysing, at lest one compound represented by general formula I,

M(R′)ₘ (I)

wherein M is an element selected from the group consisting of Si, Ti, Zr, Sn, Ce, Al, B, VO, In and Zn, R′ represents a hydrolysable radical, and m is an integer from 2 to 4. The hydrolysis step may optionally be performed in the presence of at least one compound represented by general formula II,

R_{b}SiR′ₐ, (II)

wherein the radicals R′ and R are the same or different, R′ is as defined above with formula I, R represents a group selected from an alkyl group, an alkenyl group, an aryl group, a hydrocarbon group with at least one halogen group, an epoxide group, a glycidyloxy group, an amino group, a mercapto group, a methacryloxy group and a cyano group, and a and b independently of one another have a value from 1 to 3, provided that the sum of a and b is four. The hydrolysis reaction is conducted in the presence of at least 0.6 moles of water for every mole of hydrolysable radical R′. Further described is a multilayered article which includes a substrate, a scratch-resistant coating and a top layer which is prepared from the coating composition of the invention. Also described is a process of preparing the multilayered article.

### CROSS REFERENCE TO RELATED PATENT APPLICATION

The present patent application claims the right of priority under 35 U.S.C. §119 (a)-(d) of German Patent Application No. 102 45 729.8, filed Oct. 1, 2002.

### FIELD OF THE INVENTION

The present invention relates to a process for the preparation of coating compositions and the compositions which can be obtained by this process. The invention furthermore relates to layer systems comprising a substrate (S), a scratch-resistant layer (SR) and a top layer (T) prepared from the coating composition according to the invention, and to a process for the preparation of these layer systems.

### BACKGROUND OF THE INVENTION

With the aid of sol-gel processes it is possible to prepare materials which are suitable as coatings from alkoxides such as aluminium propanolate or butanolate using modified alkoxysilanes. Typically, sol-gel processes are characterised in that a mixture of the starting components is reacted by a hydrolysis and condensation process to form a viscous liquid phase. An organically modified inorganic base matrix which has an increased surface hardness compared with conventional organic polymers is formed by this synthesis method. However, an important disadvantage of sol gel processes relates to the high reactivity of the aluminium-containing components, which results in reduced storage stability (pot life) of the reactant composition.

Compared with inorganic materials, the layers obtained by sol-gel processes are relatively soft. Even though the inorganic contents of the system provide a high level of crosslinking, the reason for the reduced layer hardness is believed to be due to the small size of the inorganic materials in the system, which reduces the mechanical properties (e.g., hardness and abrasion resistance) of the layers. By the use of filler-containing polymers, the favourable mechanical properties of the inorganic contents can be more fully utilized, since in this case the filler provides inorganic particles having sizes of several micrometres. However, the transparency of the materials is typically lost, and optical uses are typically not possible. The use of small particles of SiO₂ (e.g., Aerosils® particles) for the preparation of transparent layers having increased abrasion resistance is possible, but at the low concentrations that are typically employed the abrasion resistance of the layers is unfortunately similar to those of the above-mentioned system. The upper limit of the amount of filler is determined in part by the high surface reactivity of the small particles, which results undesirably in the formation of agglomerations or in increases in viscosity.

DE 199 52 040 A1 discloses substrates with an abrasion-resistant diffusion barrier layer system, wherein the diffusion barrier layer system comprises a hard base layer based on hydrolysable epoxysilanes and a top layer arranged on top. The top layer is obtained by application of a coating sol of tetraethoxysilane (TEOS) and glycidyloxypropyltrimethoxysilane (GPTS) and curing thereof at a temperature of <110° C. The coating sol is prepared by subjecting TEOS to prehydrolysis and condensation with ethanol as the solvent in HCl-acid aqueous solution. GPTS is then stirred into the TEOS prehydrolysed in this way and the sol is stirred for 5 hours at 50° C. A disadvantage of the coating sol described in this publication is its low storage stability (pot life), as a consequence of which the coating sol must be further processed within a few days after its preparation. A disadvantage of the diffusion barrier layer systems described in this publication is furthermore that these have results according to the Taber abrasion test which are unsatisfactory for use in automobile glazing.

DE 43 38 361 A1 describes coating compositions which comprise silicon compounds containing epoxide groups, nanoscale oxides or oxide hydrates of Si, Al, B or transition metals, where boehmite is preferred in particular, surfactants and aromatic polyols. The compositions may additionally comprise Lewis bases and alcoholates of titanium, zirconium or aluminium. The compositions are prepared by the sol-gel process, by prehydrolysing GPTS and TEOS together in HCl-acid solution, not more than about 0.5 mol of water being employed per mol of hydrolysable group. After the hydrolysis has taken place, boehmite sol is added to the composition, while cooling with ice. The coating compositions are used for the preparation of scratch-resistant layers. Over-coating of the scratch-resistant layer with a further top layer is not described in this publication.

### SUMMARY OF THE INVENTION

The invention is based on the object of providing an organically modified inorganic system which, in its hardness, is significantly superior to that of the materials described in the prior art, and has a high optical transparency. A further object of the invention is to provide for the preparation of stable intermediate products which can be used as coatings, which have properties that are substantially constant over time. In addition, another object of the invention, is to provide intermediate products which allow for modification of the physical and chemical surface properties of a coating, such as hydrophilicity/hydrophobicity and correspondingly oleophilicity/oleophobicity surface properties.

The present invention is based on the object of providing a composition with an even further improved scratch resistance, adhesion, paint viscosity and elasticity, which has a lower tendency towards gelling and hazing compared with the compositions of the prior art.

In accordance with the present invention, there is provided a process of preparing a coating composition comprising forming a hydrolysis product by hydrolysing:

(a) at least one compound represented by general formula I,

M(R′)ₘ (I)

wherein M is an element selected from the group consisting of Si, Ti, Zr, Sn, Ce, Al, B, VO, In and Zn, R′ represents a hydrolysable radical, and m is an integer from 2 to 4; and

(b) optionally at least one compound represented by general formula II,

R_{b}SiR′ₐ, (II)

wherein the radicals R′ and R are the same or different, R′ is as defined above, R represents a group selected from an alkyl group, an alkenyl group, an aryl group, a hydrocarbon group with at least one halogen group, an epoxide group, a glycidyloxy group, an amino group, a mercapto group, a methacryloxy group and a cyano group, and a and b independently of one another have a value from 1 to 3, provided that the sum of a and b is four,

wherein the hydrolysis occurs in the presence of at least 0.6 moles of water for every mole of hydrolysable radical R′.

Unless otherwise indicated, all numbers or expressions, such as those expressing quantities of ingredients, reaction conditions and so forth used in the specification and claims are understood as modified in all instances by the term “about.”

### DETAILED DESCRIPTION OF THE INVENTION

It has been found, surprisingly, that by the joint hydrolysis of the compounds of the formulae I and II envisaged in the process according to the invention, the storage stability (pot life) of the composition is improved considerably.

In contrast to the doctrine of DE 43 38 361 A1, the hydrolysis is carried out in the presence of at least 0.6 mol of water, in particular 0.8 to 2.0 mol of water, based on 1 mol of hydrolysable radicals R′. According to a preferred embodiment of the invention, a complete hydrolysis is carried out by using at least an equimolar amount of water, based on the hydrolysable radicals.

The compounds of the formulae I and II can be employed in any desired amounts. The compound of the formula II is preferably employed in an amount of less than 0.7 mol, in particular less than 0.5 mol, based on 1 mol of the compound of the formula I.

The hydrolysis is preferably carried out in the presence of acids, in particular aqueous hydrochloric acid. A pH of the reaction mixture of 2.0 to 5.0 is particularly suitable.

The hydrolysis reaction proceeds slightly exothermically and is preferably assisted by heating to 30 to 40° C. When the hydrolysis has taken place, the reaction product is preferably cooled to room temperature and stirred for some time, in particular 1 to 3 hours, at room temperature. The coating composition obtained is preferably stored at temperatures of <10° C., in particular at a temperature of about 4° C.

All the temperature data include a deviation of +2° C. Room temperature is understood as meaning a temperature of 20 to 23° C.

The over-coating sol is prepared from 100 parts of a compound of the formula I and/or of a hydrolysis product therefrom and of a compound of the formula II and/or of a hydrolysis product therefrom, the amount of the compound II, based on the 100 parts of the compound I, being less than 100 parts, preferably less than 70 parts, in particular less than 50 parts or also being omitted completely. The ready-to-apply top layer coating composition preferably has a solids content of 0.2 to 5 wt. %, in particular 0.5 to 3 wt. %.

The compound of the formula I is preferably a compound

M(R)ₘ

wherein M represents a) Si⁺⁴, Ti⁺⁴, Zr⁺⁴, Sn⁺⁴ or Ce⁺⁴ or b) Al⁺³, B⁺³, VO⁺³ or In⁺³ or c) Zn⁺², R represents a hydrolysable radical and m is 4 in the case of tetravalent elements M [case a)], 3 in the case of trivalent elements or compounds M [case b)], and 2 in the case of divalent elements [case c)]. Preferred elements for M are Si⁺⁴, Ti⁺⁴, Ce⁺⁴ and Al⁺³, and Si⁺⁴ is particularly preferred. Examples of the hydrolysable radicals are halogen (F, Cl, Br and I, in particular Cl and Br), alkoxy (in particular C₁₋₄-alkoxy, such as e.g. methoxy, ethoxy, n-propoxy, i-propoxy and n-butoxy, i-butoxy, sec-butoxy or tert-butoxy), aryloxy (in particular C₆₋₁₀-aryloxy, e.g. phenoxy), acyloxy (in particular C₁₋₄-acyloxy, such as e.g. acetoxy and propionyloxy) and alkylcarbonyl (e.g. acetyl). Particularly preferred hydrolysable radicals are alkoxy groups, in particular methoxy and ethoxy.

Specific examples of compounds of the formula I which can be employed are given in the following, but these are not intended to represent a limitation of the compounds of the formula I which can be employed.

Si(OCH₃)₄, Si(OC₂H₅)₄, Si(O-n- or i-C₃H₇)₄,

Si(OC₄H₉)₄, SiCl₄, HSiCl₃, Si(OOCCH₃)₄,

Al(OCH₃)₃, Al(OC₂H₅)₃, Al(O-n-C₃H₇)₃,

Al(O-i-C₃H₇)₃, Al(OC₄H₉)₃, Al(O-i-C₄H₉)₃,

Al(O-sec-C₄H₉)₃, AlCl₃, AlCl(OH)₂, Al(OC₂H₄OC₄H₉)₃,

TiCl₄, Ti(OC₂H₅)₄, Ti(OC₃H₇)₄,

Ti(O-i-C₃H₇)₄, Ti(OC₄H₉)₄, Ti(2-ethylhexoxy)₄;

ZrCl₄, Zr(OC₂H₅)₄, Zr(OC₃H₇)₄, Zr(O-i-C₃H₇)₄, Zr(OC₄H₉)₄,

ZrOCl₂, Zr(2-ethylhexoxy)₄

and Zr compounds which contain complexing radicals, such as e.g. β-diketone and methacryl radicals,

BCl₃, B(OCH₃)₃, B(OC₂H₅)₃,

SnCl₄, Sn(OCH₃)₄,

Sn(OC₂H₅)₄,

VOCl₃, VO(OCH₃)₃,

Ce(OC₂H₅)₄, Ce(OC₃H₄)₄, Ce(OC₄H₉)₄, Ce(O-i-C₃H₇)₄, Ce(2-ethylhexoxy)₄, Ce(SO₄)₂, Ce(ClO₄)₄, CeF₄, CeCl₄, CeAc₄,

In(CH₃COO)₃, In[CH₃COCH═C(O—)CH₃]₃,

InBr₃, [(CH₃)₃CO]₃In, InCl₃, InF₃,

[(CH₃I₂)CHO]₃In, InI₃, In(NO₃)₃, In(ClO₄)₃, In₂ (SO₄)₃, In₂S₃,

(CH₃COO)₂Zn, [CH₃COCH═C(O—)CH₃]₂Zn,

ZnBr₂, ZnCO₃.2 Zn(OH)₂×H₂O, ZnCl₂,

zinc citrate, ZnF₂, ZnI, Zn(NO₃)₂.H₂O, ZnSO₄.H₂O.

Compounds SiR₄, wherein the radicals R can be identical or different and represent a hydrolysable group, preferably an alkoxy group having 1 to 4 carbon atoms, in particular methoxy, ethoxy, n-propoxy, i-propoxy, n-butoxy, i-butoxy, sec-butoxy or tert-butoxy, are particularly preferably employed.

A tetraalkoxysilane, in particular tetraethoxysilane (TEOS), is very particularly preferred.

The compound of the formula II is preferably a compound

R_{b}SiR′ₐ, (II)

wherein the radicals R and R′ are identical or different (preferably identical), the R′ represent a hydrolysable group (preferably C₁₋₄-alkoxy, and in particular methoxy and ethoxy) and the R represent an alkyl (preferably C₁-C₈) group, an alkenyl (preferably C₂-C₈) group, an aryl (preferably C₆-C₁₀) group or a hydrocarbon group (preferably C₁-C₂₀) with one or more halogen groups, an epoxide group, a glycidyloxy group, an amino group, a mercapto group, a methacryloxy group or a cyano group.

In formula II, subscript (a) can assume the values 1 to 3, and subscript (b) can also assume the values 1 to 3, provided that the sum of (a+b) is four.

Examples of compounds of the formula II include, but are not limited to:

trialkoxysilanes, triacyloxysilanes and triphenoxysilanes, those such as methyltrimethoxysilane, methyltriethoxysilane, methyltrimethoxyethoxysilane, methyltriacetoxysilane, methyltributoxysilane, ethyltrimethoxysilane, ethyltriethoxysilane, vinyltrimethoxysilane, vinyltriethoxysilane, vinyltriacetoxysilane, vinyltrimethoxyethoxysilane, phenyltrimethoxysilane, phenyltriethoxysilane, phenyltriacetoxysilane, γ-chloropropyltrimethoxysilane, γ-chloropropyltriethoxysilane, γ-chloropropyltriacetoxysilane, 3,3,3-trifluoropropyltrimethoxysilane, γ-methacryloxypropyltrimethoxysilane, γ-aminopropyltrimethoxysilane, γ-mercaptopropyltrimethoxysilane, γ-mercaptopropyltriethoxysilane, N-β-(aminoethyl)-γ-aminopropyltrimethoxysilane, β-cyanoethyltriethoxysilane, methyltriphenoxysilane, chloromethyltrimethoxysilane, chloromethyltriethoxysilane, glycidoxymethyltrimethoxysilane, glycidoxymethyltriethoxysilane, α-glycidoxyethyltrimethoxysilane, α-glycidoxyethyltriethoxysilane, β-glycidoxyethyltrimethoxysilane, β-glycidoxyethyltriethoxysilane, α-glycidoxypropyltrimethoxysilane, α-glycidoxypropyltriethoxysilane, β-glycidoxypropyltrimethoxysilane, β-glycidoxypropyltriethoxysilane, γ-glycidoxypropyltrimethoxysilane, γ-glycidoxypropyltriethoxysilane, γ-glycidoxypropyltripropoxysilane, γ-glycidoxypropyltributoxysilane, γ-glycidoxypropyltrimethoxyethoxysilane, γ-glycidoxypropyltriphenoxysilane, α-glycidoxybutyltrimethoxysilane, α-glycidoxybutyltriethoxysilane, β-glycidoxybutyltrimethoxysilane, β-glycidoxybutyltriethoxysilane, γ-glycidoxybutyltrimethoxysilane, γ-glycidoxybutyltriethoxysilane, δ-glycidoxybutyltrimethoxysilane, δ-glycidoxybutyltriethoxysilane, (3,4-epoxycyclohexyl)methyltrimethoxysilane, (3,4-epoxycyclohexyl)methyltrimethoxysilane, β-(3,4-epoxycyclohexyl)ethyltrimethoxysilane, β-(3,4-epoxycyclohexyl)ethyltrimethoxysilane, β-(3,4-epoxycyclohexyl)ethyltripropoxysilane, β-(3,4-epoxycyclohexyl)ethyltributoxysilane, β-(3,4-epoxycyclohexyl)ethyldimethoxyethoxysilane, β-(3,4-epoxycyclohexyl)ethyltriphenoxysilane, γ-(3,4-epoxycyclohexyl)propyltrimethoxysilane, γ-(3,4-epoxycyclohexyl)propyltrimethoxysilane, δ-(3,4-epoxycyclohexyl)butyltrimethoxysilane, δ-(3,4-epoxycyclohexyl)butyltriethoxysilane and hydrolysis products therefrom, and dialkoxysilanes and diacyloxysilanes, such as e.g. dimethyldimethoxysilane, phenylmethyldimethoxysilane, dimethyldiethoxysilane, phenylmethyldiethoxysilane, γ-chloropropylmethyldimethoxysilane, γ-chloropropylmethyldiethoxysilane, dimethyldiacetoxysilane, γ-methacryloxypropylmethyldimethoxysilane, γ-methacryloxypropylmethyld iethoxysilane, γ-mercaptopropylmethyldimethoxysilane, γ-mercaptopropylmethyldiethoxysilane, γ-aminopropylmethyldimethoxysilane, γ-aminopropylmethyldiethoxysilane, methylvinyldimethoxysilane, methylvinyidiethoxysilane, glycidoxymethylmethyldimethoxysilane, glycidoxymethylmethyldiethoxysilane, α-glycidoxyethylmethyldimethoxysilane, α-glycidoxyethylmethyldiethoxysilane, β-glycidoxyethylmethyldimethoxysilane, β-glycidoxyethylmethyldiethoxysilane, α-glycidoxypropylmethyldimethoxysilane, α-glycidoxypropylmethyldiethoxysilane, β-glycidoxypropylmethyldimethoxysilane, β-glycidoxypropylmethyldiethoxysilane, γ-glycidoxypropylmethyldimethoxysilane, γ-glycidoxypropylmethyldiethoxysilane, γ-glycidoxypropylmethyldipropoxysilane, γ-glycidoxypropylmethyldibutoxysilane, γ-glycidoxypropylmethyldimethoxyethoxysilane, γ-glycidoxypropylmethyldiphenoxysilane, γ-glycidoxypropylethyldimethoxysilane, γ-glycidoxypropylethyldiethoxysilane, γ-glycidoxypropylethyldipropoxysilane, γ-glycidoxypropylvinyldimethoxysilane, γ-glycidoxypropylvinyldiethoxysilane, γ-glycidoxypropylphenyldimethoxysilane, γ-glycidoxypropylphenyldiethoxysilane, and products and hydrolysis products therefrom.

The examples of formula II may be used individually or as a mixture of two or more.

Preferred compounds of the formula II are methyltrialkoxysilane, dimethyldialkoxysilane, gycidyloxypropyltrialkoxysilane and/or methacryloxypropyltrimethoxysilane. Particularly preferred compounds of the formula II are glycidyloxypropyltrimethoxysilane (GPTS), methyltriethoxysilane (MTS) and/or methacryloxypropyltrimethoxysilane (M PTS).

Water and inert solvents or solvent mixtures can optionally be added at any desired stage of the preparation, in particular during the hydrolysis, in order to adjust the rheological properties of the compositions. These solvents are preferably alcohols which are liquid at room temperature, which are moreover also formed during the hydrolysis of the alkoxides preferably employed. Particularly preferred alcohols are C₁₋₈-alcohols, in particular methanol, ethanol, n-propanol, i-propanol, n-butanol, i-butanol, tert-butanol, n-pentanol, i-pentanol, n-hexanol and n-octanol. C₁₋₆-Glycol ethers, in particular n-butoxyethanol, are also preferred. Isopropanol, ethanol, butanol and/or water is particularly suitable as the solvent.

The compositions can furthermore comprise conventional additives, such as e.g. dyestuffs, flow control agents, UV stabilizers, IR stabilizers, photoinitiators, photosensitizers (if photochemical curing of the composition is intended) and/or thermal polymerization catalysts. Flow control agents are, in particular, those based on polyether-modified polydimethylsiloxanes. It has proved particularly advantageous if the coating compositions comprise flow control agents in an amount of about 0.005 to 2 wt. %.

The coating composition prepared in this way can be employed for coating the most diverse substrates. The choice of the substrate materials for coating is not limited. The compositions are preferably suitable for coating wood, textiles, paper, stoneware, metals, glass, ceramic and plastics, and here in particular for coating thermoplastics, such as are described in Becker/Braun, Kunststofflaschenbuch, Carl Hanser Verlag, Munich, Vienna 1992. The compositions are very particularly suitable for coating transparent thermoplastics, and preferably polycarbonates. In particular, spectacle lenses, optical lenses, automobile windows and sheets can be coated with the compositions obtained according to the invention.

The application to the substrate is carried out by standard coating processes, such as e.g. dipping, flow-coating, spreading, brushing, knife-coating, rolling, spraying, falling film application, spin-coating and whirler-coating.

Curing of the coated substrate is carried out optionally after prior surface-drying at room temperature. The curing is preferably carried out by means of heat at temperatures in the range from 50 to 200° C., in particular 70 to 180° C. and particularly preferably 90 to 150° C. Under these conditions the curing time should be 30 to 200 minutes, preferably 45 to 120 minutes. The layer thickness of the cured top layer should be 0.05 to 5 μm, preferably 0.1 to 3 μm.

If unsaturated compounds and photoinitiators are present, the curing can also be carried out by irradiation, which is optionally followed by after-curing by means of heat.

The coating compositions prepared by the process according to the invention are suitable in particular for the preparation of top layers (D) in scratch-resistant coating systems. The coating compositions prepared by the process according to the invention are particularly suitable for application to scratch-resistant layers (SR) based on hydrolysable silanes with epoxide groups. Preferred scratch-resistant layers (SR) are those which are obtainable by curing of a coating composition comprising a polycondensate, prepared by the sol-gel process, based on at least one silane which has an epoxide group on a non-hydrolysable substituent and optionally a curing catalyst chosen from Lewis bases and alcoholates of titanium, zirconium or aluminium. The preparation and properties of such scratch-resistant layers (SR) are described, for example, in DE 43 38 361 A1.

Scratch-resistant layers (SR) which are over-coated with the coating composition prepared by the process according to the invention are preferably those which are prepared from a coating composition comprising

a silicon compound (A) with at least one radical R which cannot be split off by hydrolysis, is bonded directly to Si and contains an epoxide group,

particulate materials (B),

a hydrolysable compound (C) of Si, Ti, Zr, B, Sn or V and preferably additionally

a hydrolysable compound (D) of Ti, Zr or Al.

Such coating compositions result in highly scratch-resistant coatings which adhere particularly well to the material.

The compounds (A) to (D) are explained in more detail in the following. The compounds (A) to (D) can be contained not only in the composition for the scratch-resistant layer (SR), but also as additional component(s) in the composition for the top layer (T)

Silicon Compound (A)

The silicon compound (A) is a silicon compound which has 2 or 3, preferably 3, hydrolysable radicals and one or 2, preferably one, non-hydrolysable radical. The only or at least one of the two non-hydrolysable radicals has an epoxide group.

Examples of the hydrolysable radicals are halogen (F, Cl, Br and 1, in particular Cl and Br), alkoxy (in particular C₁₋₄-alkoxy, such as e.g. methoxy, ethoxy, n-propoxy, i-propoxy and n-butoxy, i-butoxy, sec-butoxy and tert-butoxy), aryloxy (in particular C₆₋₁₀-aryloxy, e.g. phenoxy), acyloxy (in particular C₁₋₄-acyloxy, such as e.g. acetoxy and propionyloxy) and alkylcarbonyl (e.g. acetyl). Particularly preferred hydrolysable radicals are alkoxy groups, in particular methoxy and ethoxy.

Examples of non-hydrolysable radicals without an epoxide group are hydrogen, alkyl, in particular C₁₋₄-alkyl (such as e.g. methyl, ethyl, propyl and butyl), alkenyl (in particular C₂₋₄-alkenyl, such as e.g. vinyl, 1-propenyl, 2-propenyl and butenyl), alkinyl (in particular C₂₋₄-alkinyl, such as e.g. acetylenyl and propargyl) and aryl, in particular C₆₋₁₀-aryl, such as e.g. phenyl and naphthyl), it being possible for the groups just mentioned optionally to contain one or more substituents, such as e.g. halogen and alkoxy. Methacryl and methacryloxypropyl radicals may also be mentioned in this connection.

Examples of non-hydrolysable radicals with an epoxide group are, in particular, those which have a glycidyl or glycidyloxy group.

Examples of silicon compounds (A) which can be employed according to the invention may be found, for example, on pages 8 and 9 of EP-A-1 95 493.

Silicon compounds (A) which are particularly preferred according to the invention are those of the general formula

R₃SiR′

in which the radicals R are identical or different (preferably identical) and represent a hydrolysable group (preferably C₁₋₄-alkoxy and in particular methoxy and ethoxy) and R′ represent a a glycidyl or glycidyloxy-(C₁₋₂₀)-alkylene radical, in particular β-glycidyloxyethyl, γ-glycidyloxypropyl, δ-glycidyloxybutyl, ε-glycidyloxypentyl, ω-glycidyloxyhexyl, ω-glycidyloxyoctyl, ω-glycidyloxynonyl, ω-glycidyloxydecyl, ω-glycidyloxydodecyl and 2-(3,4-Epoxycyclohexyl)-ethyl.

γ-Glycidyloxy-propyltrimethoxysilane (abbreviated to GPTS in the following) is particularly preferably employed according to the invention because of its easy accessiblity.

Particulate materials (B),

The particulate materials (B) may be an oxide, oxide hydrate, nitride or carbide of Si, Al and B and of transition metals, preferably Ti, Zr and Ce, with a particle size in the range from 1 to 100, preferably 2 to 50 nm and particularly preferably 5 to 20 nm and mixtures thereof. These materials can be employed in the form of a powder, but are preferably used in the form of a sol (in particular an acid-stabilized sol). Preferred particulate materials are boehmite, SiO₂, CeO₂, ZnO, In₂O₃ and TiO₂. Nanoscale boehmite particles are particularly preferred. The particulate materials are commercially obtainable in the form of powders, and the preparation of (acid-stabilized) sols therefrom is also known in the prior art. Reference can moreover be made in this context to the preparation examples described below. The principle of stabilization of nanoscale titanium nitride by means of guanidinepropionic acid is described e.g. in German Patent Application DE-43 34 639 A1.

Boehmite sol with a pH in the range from 2.5 to 3.5, preferably 2.8 to 3.2, which can be obtained, for example, by suspending boehmite powder in dilute HCl, is particularly preferably employed.

The variation of the nanoscale particles is as a rule accompanied by a variation in the refractive index of the corresponding materials. Thus, for example, the replacement of boehmite particles by CeO₂, ZrO₂ or TiO₂ particles leads to materials with higher refractive indices, the refractive index resulting additively from the volume of the component of high refractive index and the matrix in accordance with the Lorentz-Lorenz equation.

As mentioned, cerium dioxide can be employed as the particulate material. This preferably has a particle size in the range from 1 to 100, preferably 2 to 50 nm and particularly preferably 5 to 20 nm. This material can be employed in the form of a powder, but is preferably used in the form of a sol (in particular an acid-stabilized sol). Particulate cerium oxide is commercially obtainable in the form of sols and powders, and the preparation of (acid-stabilized) sols therefrom is also known in the prior art.

Compound (B) is preferably employed in the composition for the scratch-resistant layer (SR) in an amount of 3 to 60 wt. %, based on the solids content of the coating composition for the scratch-resistant layer (SR).

Hydrolysable Compounds (C)

In addition to the silicon compounds (A), other hydrolysable compounds of elements from the group consisting of Si, Ti, Zr, Al, B, Sn and V are also used for the preparation of the scratch-resistant layer coating composition and are preferably hydrolysed with the silicon compound(s) (A).

The compound (C) is a compound of Si, Ti, Zr, B, Sn and V of the general formula

RₓM⁺⁴R′₄₋ₓ or

RₓM⁺³R′₃₋ₓ

wherein M represents a) Si⁺⁴, Ti⁺⁴, Zr⁺⁴ or Sn⁺⁴, or b) Al⁺³, B⁺³ or (VO)⁺³, R represents a hydrolysable radical, R′ represents a non-hydrolysable radical and x can be 1 to 4 in the case of tetravalent metal atoms M (case a)) and 1 to 3 in the case of trivalent metal atoms M (case b)). If several radicals R and/or R′ are present in a compound (C), these can in each case be identical or different. Preferably, x is greater than 1. That is to say the compound (C) contains at least one, preferably several, hydrolysable radicals.

Examples of the hydrolysable radicals are halogen (F, Cl, Br and I, in particular Cl and Br), alkoxy (in particular C₁₋₄-alkoxy, such as e.g. methoxy, ethoxy, n-propoxy, i-propoxy and n-butoxy, i-butoxy, sec-butoxy or tert-butoxy), aryloxy (in particular C₆₋₁₀-aryloxy, e.g. phenoxy), acyloxy (in particular C₁₋₄-acyloxy, such as e.g. acetoxy and propionyloxy) and alkylcarbonyl (e.g. acetyl). Particularly preferred hydrolysable radicals are alkoxy groups, in particular methoxy and ethoxy.

Examples of non-hydrolysable radicals are hydrogen, alkyl, in particular C₁₋₄-alkyl (such as e.g. methyl, ethyl, propyl and n-butyl, i-butyl, sec-butyl and tert-butyl), alkenyl (in particular C₂₋₄-alkenyl, such as e.g. vinyl, 1-propenyl, 2-propenyl and butenyl), alkinyl (in particular C₂₋₄-alkinyl, such as e.g. acetylenyl and propargyl) and aryl, in particular C₆₋₁₀-aryl, such as e.g. phenyl and naphthyl), it being possible for the groups just mentioned optionally to contain one or more substituents, such as e.g. halogen and alkoxy. Methacryl and methacryloxypropyl radicals may also be mentioned in this connection.

In addition to the above examples of compounds of the formula I contained in the top layer composition, the following preferred examples may be mentioned for the compound (C):

CH₃—SiCl₃, CH₃—Si(OC₂H₅)₃, C₂H₅—SiCl₃, C₂H₅—Si(OC₂H₅)₃,

C₃H₇—Si(OCH₃)₃, C₆H₅—Si(OCH₃)₃, C₆H₅—Si(OC₂H₅)₃,

(CH₃O)₃—Si—C₃H₆—Cl,

(CH₃)₂SiCl₂, (CH₃)₂Si(OCH₃)₂, (CH₃)₂Si(OC₂H₅)₂,

(CH₃)₂Si(OH)₂, (C₆H₅)₂SiCl₂, (C₆H₅)₂Si(OCH₃)₂,

(C₆H₅)₂Si(OC₂H₅)₂, (i-C₃H₇)₃SiOH,

CH₂═CH—Si(OOCCH₃)₃,

CH₂═CH—SiCl₃, CH₂═CH—Si(OCH₃)₃, CH₂═CH—Si(OC₂H₅)₃,

CH₂═CH—Si(OC₂H₄OCH₃)₃, CH₂═CH—CH₂—Si(OCH₃)₃,

CH₂═CH—CH₂—Si(OC₂H₅)₃,

CH₂═CH—CH₂—Si(OOCCH₃)₃,

CH₂═C(CH₃)—COO—C₃H₇—Si(OCH₃)₃,

CH₂═C(CH₃)—COO—C₃H₇—Si(OC₂H₅)₃.

Compounds of the type SiR₄, wherein the radicals R can be identical or different and represent a hydrolysable group, preferably an alkoxy group having 1 to 4 carbon atoms, in particular methoxy, ethoxy, n-propoxy, i-propoxy, n-butoxy, i-butoxy, sec-butoxy or tert-butoxy, are particularly preferably employed.

As can be seen, these compounds (C) (in particular the silicon compounds) also have non-hydrolysable radicals which contain a C—C double bond or triple bond. If such compounds are employed together with (or even instead of) the silicon compounds (A), monomers (preferably containing epoxide or hydroxyl groups) such as e.g. meth(acrylates) can also additionally be incorporated into the composition (these monomers can of course also have two or more functional groups of the same type, such as e.g. poly(meth)acrylates of organic polyols; the use of organic polyepoxides is also possible). In the case of curing of the corresponding composition induced by heat or photochemically, a polymerization of the organic species then takes place in addition to the build-up of the organically modified inorganic matrix, as a result of which the crosslinking density and therefore also the hardness of the corresponding coatings and shaped articles increases.

Compound (C) is preferably employed in the composition for the scratch-resistant layer (SR) in an amount of 0.2 to 1.2 mol, based on 1 mol of silicon compound (A).

Hydrolysable Compound (D)

The hydrolysable compound (D) is a compound of Ti, Zr or Al of the following general formula

M(R′″)ₘ

wherein M represents Ti, Zr or Al and the radicals R′″ can be identical or different and represent a hydrolysable group and n is 4 (M=Ti, Zr) or 3(M=Al).

Examples of the hydrolysable groups are halogen (F, Cl, Br and 1, in particular Cl and Br), alkoxy (in particular C₁₋₆-alkoxy, such as e.g. methoxy, ethoxy, n-propoxy, i-propoxy and n-butoxy, i-butoxy, sec-butoxy or tert-butoxy, n-pentyloxy, n-hexyloxy), aryloxy (in particular C₆₋₁₀-aryloxy, e.g. phenoxy), acyloxy (in particular C₁₋₄-acyloxy, such as e.g. acetoxy and propionyloxy) and alkylcarbonyl (e.g. acetyl), or a C₁₋₆-alkoxy-C₂₋₃-alkyl group, i.e. a group derived from C₁₋₆-alkylethylene glycol or -propylene glycol, wherein alkoxy has the same meaning as mentioned above.

Particularly preferably, M is aluminium and R′″ is ethanolate, sec-butanolate, n-propanolate or n-butoxyethanolate.

Compound (D) is preferably employed in the composition for the scratch-resistant layer (SR) in an amount of 0.23 to 0.68 mol, based on 1 mol of the silicon compound (A).

A Lewis base (E) can additionally be used as a catalyst to achieve a more hydrophilic character of the scratch-resistant layer coating composition.

A hydrolysable silicon compound (F) with at least one non-hydrolysable radical which has 5 to 30 fluorine atoms bonded directly to carbon atoms, these carbon atoms being separated by at least 2 atoms of Si, can furthermore additionally be employed. The use of such a fluorinated silane leads to hydrophobic and soil-repellent properties additionally being imparted to the corresponding coating.

The preparation of the compositions for the scratch-resistant layer (SR) can be carried out by the process described in more detail below, in which a sol of the material (B) with a pH in the range from 2.0 to 6.5, preferably 2.5 to 4.0, is reacted with a mixture of the other components.

Even more preferably, they are prepared by a process, also defined below, in which the sol as defined above is added in two part portions to the mixture of (A) and (C), particular temperatures preferably being maintained, and the addition of (D) taking place between the two portions of (B), also preferably at a particular temperature.

The hydrolysable silicon compound (A) can optionally be prehydrolysed together with the compound (C) using an acid catalyst (preferably at room temperature) in aqueous solution, about 1/2 mol of water preferably being employed per mol of hydrolysable group. Hydrochloric acid is preferably employed as the catalyst for the prehydrolysis.

The particulate materials (B) are preferably suspended in water and the pH is adjusted to 2.0 to 6.5, preferably to 2.5 to 4.0. Hydrochloric acid is preferably used for the acidification. If boehmite is used as the particulate material (B), a clear sol forms under these conditions.

The compound (C) is mixed with the compound (A). The first part portion of the particulate material (B), suspended as described above, is then added. The amount is preferably chosen such that the water contained therein is sufficient for semi-stoichiometric hydrolysis of the compounds (A) and (C). It is 10 to 70 wt. % of the total amount, preferably 20 to 50 wt. %.

The reaction proceeds slightly exothermically. After the first exothermic reaction has subsided, the temperature is adjusted by heating to approx. 28 to 35° C., preferably approx. 30 to 32° C., until the reaction starts and an internal temperature which is higher than 25° C., preferably higher than 30° C., and even more preferably higher than 35° C. is reached. When the addition of the first portion of the material (B) has ended, the temperature is maintained for a further 0.5 to 3 hours, preferably 1.5 to 2.5 hours, and the mixture is then cooled to approx. 0° C. The remaining material (B) is preferably added slowly at a temperature of 0° C. Thereafter, the compound (D) and optionally the Lewis base (E) are slowly added at approx. 0° C., also preferably after the addition of the first part portion of the material (B). The temperature is then kept at approx. 0° C. for 0.5 to 3 hours, preferably for 1.5 to 2.5 hours, before addition of the second portion of the material (B). Thereafter, the remaining material (B) is added slowly at a temperature of approx. 0° C. The solution added dropwise is preferably precooled here to approx. 10° C. directly before the addition into the reactor.

After the slow addition of the second part portion of the compound (B) at approx. 0° C., the cooling is preferably removed so that the warming up of the reaction mixture to a temperature of more than 15° C. (to room temperature) takes place slowly, without additional heating.

Inert solvents or solvent mixtures can optionally be added at any desired stage of the preparation in order to adjust the rheological properties of the scratch-resistant layer compositions. These solvents are preferably the solvents already described above for the top layer composition.

The scratch-resistant layer compositions can comprise the conventional additives already described above for the top layer composition.

The application and curing of the scratch-resistant layer composition are carried out after surface-drying preferably by means of heat at 50 to 200° C., preferably 70 to 180° C., and in particular 110 to 130° C. Under these conditions the curing time should be less than 120, preferably less than 90, in particular less than 60 minutes.

The layer thickness of the cured scratch-resistant layer (SR) should be 0.5 to 30 μm, preferably 1 to 20 μm and in particular 2 to 10 μm.

The invention accordingly also provides a layer system comprising

(a) a substrate (S),

(b) optionally a primer layer

(c) a scratch-resistant layer (SR), as described above, and

(d) a top layer (T) formed from the composition prepared by the process according to the invention.

Any desired materials are possible as the substrate (S), in particular the materials described above as substrates for the top layer (T). The substrate (S) is preferably mouldings, sheets and films of plastic, in particular based on polycarbonate.

The layer systems according to the invention can be prepared by a process which comprises at least the following steps:

(a) application of the scratch-resistant layer coating composition to the substrate (S) and partial curing or polymerization of the coating composition under conditions such that groups which are still reactive are present.

(b) application of the top layer coating composition according to the invention to the incompletely cured or polymerized scratch-resistant layer (SR) prepared in this way and curing thereof to form a top layer (T).

In the preparation of the layer systems it has proved to be particularly advantageous if the scratch-resistant layer (SR) is dried at a temperature of >110° C., in particular 110 to 130° C., after the application. Excellent abrasion properties of the layer systems can be achieved by this means.

It is furthermore advantageous if the scratch-resistant layer coating composition comprises flow control agents in an amount of 0.03 to 1 wt. %.

It has furthermore proved to be particularly advantageous if the top layer coating composition is applied at a relative humidity of 50 to 75%, in particular 55 to 70%.

Finally, it has proved to be advantageous if the cured scratch-resistant layer (SR) is activated before application of the top layer coating composition. Possible activation processes are, preferably, corona treatment, flaming, plasma treatment or chemical etching. Flaming and corona treatment are particularly suitable. Reference is made to the embodiment examples in respect of the advantageous properties.

The present invention is more particularly described in the following examples, which are intended to be illustrative only, since numerous modifications and variations therein will be apparent to those skilled in the art. Unless otherwise specified, all parts and percentages are by weight.

### EXAMPLES

Preparation of the Coating Composition for the Scratch-Resistant Layer (SR)

### Example 1

354.5 g (3.0 mol) n-butoxyethanol were added dropwise to 246.3 g (1.0 mol) aluminium tri-sec-butanolate while stirring, during which the temperature rose to approx. 45° C. After cooling, the aluminate solution must be stored in a closed container.

1,239 g 0.1 N HCl were initially introduced into the reaction vessel. 123.9 g (1.92 mol) Bohmit Dispersal Sol P3® were added, while stirring. The mixture was then stirred for 1 hour at room temperature. The solution was filtered through a deep filter to separate off solid impurities.

787.8 g (3.33 mol) GPTS (y-glycidyloxypropyltrimethoxysilane) and 608.3 g TEOS (tetraethoxysilane) (2.92 mol) were mixed and stirred for 10 minutes. 214.6 g of the boehmite sol were added to this mixture in the course of approx. 2 minutes. A few minutes after the addition the sol heated up to approx. 28 to 30° C. and was also clear after approx. 20 minutes. The mixture was then stirred for approx. 2 hours at 35° C. and then cooled to approx. 0° C.

600.8 g of the Al(OEtOBu)₃ solution in sec-butanol prepared as described above, containing 1.0 mol Al(OEtOBu)₃, were then added at 0° C. ±2° C. When the addition had ended, the mixture was stirred for a further 2 hours at approx. 0° C. and the remaining boehmite sol was then also added at 0° C.±2° C. Warming of the reaction mixture obtained to room temperature without heating then took place in the course of approx. 3 hours. Byk 306® was added as a flow control agent. The mixture was filtered and the paint obtained was stored at +4° C.

### Example 2

Preparation of the Coating Composition

GPTS and TEOS are initially introduced into the reaction vessel and mixed. The amount of boehmite dispersion (prepared analogously to example 1) necessary for semi-stoichiometric prehydrolysis of the silanes is slowly poured in, while stirring. The reaction mixture is then stirred for 2 hours at room temperature. The solution is then cooled to 0° C. with the aid of a thermostat. Aluminium tributoxyethanolate is subsequently added dropwise via a dropping funnel. After addition of the aluminate, the mixture is stirred for a further 1 hour at 0° C. Thereafter, the remainder of the boehmite dispersion is added under thermostat cooling. After stirring for 15 minutes at room temperature, the cerium dioxide dispersion and BYK 306®, as a flow control agent, are added.

Batch Amounts:

| | | |
|---|---|---|
| TEOS | 62.50 g | (0.3 mol) |
| DMDMS | | |
| GPTS | 263.34 g | (1 mol) |
| Boehmite | 5.53 g | (2 wt. %, based on |
| | | the total solids) |
| 0.1 N Hydrochloric acid | 59.18 g | |
| Cerium dioxide dispersion | 257.14 g | (20 wt. %, based on |
| (20 wt. % in 2.5 wt. % | | the total solids) |
| acetic acid) | | |
| Boehmite dispersion for | 41.38 g | |
| semi-stoichiometric | | |
| prehydrolysis | | |
| Aluminium | 113.57 g | (0.3 mol) |
| tributoxyethanolate | | |

Preparation of the Coating Composition for the Top Layer (T)

### Example 3

A mixture of 130.0 g 2-propanol, 146,6 g distilled water and 2.8 g 37% hydrochloric acid was rapidly added dropwise to a mixture of 200.0 g TEOS and 20.0 g GPTS in 130.0 g 2-propanol. An exothermic reaction occurs, which is assisted by heating to 30 to 40° C. The reaction product is then cooled to room temperature and stirred for 1.5 hours. The coating sol obtained is stored under cool conditions at +4° C. Before use, this concentrate is diluted with isopropanol to a solids content of 1,0 wt. % and 1.0 wt. % of the flow control agent BYK 347 (based on the solids content) is added.

Preparation of the Scratch-Resistant Coating Systems

Test pieces were obtained as follows with the coating compositions obtained:

Sheets of polycarbonate based on bisphenol A (Tg=147° C., M_{W} 27,500) of dimensions 105×150×4 mm were cleaned with isopropanol and primed by flow-coating with a primer solution of 6 parts Araldite PZ 3962 and 1.32 parts Araldite PZ 3980 in 139.88 g diacetone alcohol according to the patent application PCT/EP01/03809 with subsequent heat treatment at 130° C. for half an hour.

The primed polycarbonate sheets were then flow-coated with the base coat coating composition (example 1 or 2). The air-drying time for dust drying was 30 minutes at 23° C. and 63% relative atmospheric humidity. The dust-dry sheets were heated in an oven at 130° C. for 30 minutes and then cooled to room temperature.

Thereafter, the top layer coating composition (example 3) was applied, also by flow-coating. The wet film was air-dried for 30 minutes at 23° C. and 63% relative atmospheric humidity and the sheets were than heated at 130° C. for 120 minutes.

A surface activation of the cured scratch-resistant layer by flaming, corona treatment, plasma activation or chemical etching etc. proved particularly favourable for improving the adhesion and the flow of the top coat coating composition.

The application parameters such as temperature, time, humidity, layer thickness, application process and the content and type of flow control agent used were furthermore varied for comparison.

After curing had taken place the coated sheets were stored for two days at room temperature and then subjected to the following defined tests.

The properties of the coatings obtained with these paints were determined as follows:

Cross-hatch test: EN ISO 2409:1994

Cross-hatch test after storage in water: 65° C., tt=0/0

The coated sheets are provided with a cross-hatch according to EN ISO 2409:1994 and stored in hot water of 65° C. The storage time (days) from which the first loss of adhesion in the tape test from 0 to 2 occurs is recorded.

Taber Abraser test: Abrasion test DIN 52347; (1,000 cycles, CS10F, 500 g)

The results of the evaluation are shown in tables 1 to 9.

Table 1 shows the abrasion (Taber values) and adhesion properties (cross-hatch test) of the layer systems prepared. The results show that the layer systems finished with the top layer (T) prepared according to the invention (examples 4 and 5) have considerably better abrasion and adhesion properties than those which comprise no top layer (T) (comparison examples 6 and 7).

TABLE 1

| | Scratch- | | Taber | Cross-hatch test |
|---|---|---|---|---|
| Layer | resistant | Top layer | Abraser test | after storage in |
| system | layer (SR) | (T) | hazing (%) | water (days) |
| Example 4 | Example 1 | Example 3 | 0.2 | >14 |
| Example 5 | Example 2 | Example 3 | 1.5 | >14 |
| Comparison | Example 1 | none | 0.9 | 14 |
| Example 6 | | | | |
| Comparison | Example 2 | none | 4.4 | 7 |
| Example 7 | | | | |

The wetting and flow properties of the top layer coating composition on application to the scratch-resistant layer (SR) and the abrasion properties (Taber values) of the layer systems resulting therefrom as a function of the amount of flow control agent contained in the scratch-resistant layer coating composition are shown in table 2. The results show that particularly good wetting and abrasion value are achieved if the scratch-resistant layer coating composition comprises the flow control agent BYK 306 in an amount of 0.05 to 0.2 wt. %.

TABLE 2

| | | | Flow control | | |
|---|---|---|---|---|---|
| | | | agent BYK | Wetting/ | Taber |
| | Scratch- | | 306 (wt. %) | flow of | Abraser |
| | resistant | Top layer | in the base | the top | test |
| Layer system | layer (SR) | (T) | coat | layer | hazing (%) |
| Example 8 | Example 2 | Example 3 | 0.1 | good | 1.5 |
| Example 9 | Example 2 | Example 3 | 0.3 | good | 3.4 and |
| | | | | | partial |
| | | | | | rubbing |
| | | | | | off |
| Example 10 | Example 2 | Example 3 | 0.03 | inadequate | n.d. |

Table 3 shows the abrasion properties (Taber values) of the layer systems as a function of the stoving time and temperature of the scratch-resistant layer (SR). The results show that the increase in the stoving temperature to values greater than 110° C. is accompanied by an improvement in the Taber values.

TABLE 3

| | | | Stoving | | |
|---|---|---|---|---|---|
| | | | temperature | Stoving | |
| | | | after | time after | |
| | | | application | application | |
| | | | of the | of the | Taber |
| | Scratch- | | scratch- | scratch- | Abraser |
| | resistant | Top layer | resistant | resistant | test |
| Layer system | layer (SR) | (T) | layer (° C.) | layer (min) | hazing (%) |
| Example 11 | Example 2 | Example 3 | 130 | 30 | 1.5 |
| Example 12 | Example 2 | Example 3 | 130 | 60 | partial |
| | | | | | rubbing off |
| | | | | | of the top |
| | | | | | layer |
| Example 13 | Example 2 | Example 3 | 120 | 30 | 1.7 |
| Example 14 | Example 2 | Example 3 | 110 | 30 | 2.0 |
| Example 15 | Example 2 | Example 3 | 100 | 30 | 3.4 |

Table 4 shows the abrasion properties (Taber values) of the layer systems as a function of the solids content of the top layer (T). The results show that particularly good Taber values are achieved if the solids content in the top layer is 0.5 to 1.5 wt. %.

TABLE 4

| | | | | Taber | |
|---|---|---|---|---|---|
| | Scratch- | | Solids | Abraser | |
| | resistant | Top layer | of the top | test | |
| Layer system | layer (SR) | (T) | layer | hazing % | Observation |
| Example 16 | Example 2 | Example 3 | 1.0% | 1.5 | OK |
| Example 17 | Example 2 | Example 3 | 2.0% | 4.1 | cracking at |
| | | | | | the sheet |
| | | | | | edge |
| Example 18 | Example 2 | Example 3 | 3.0% | 3.5 | cracking |
| | | | | | over the |
| | | | | | entire sheet |

Table 5 shows the abrasion properties (Taber values) of the layer systems as a function of the type and amount of flexibilizing agent contained in the top layer coating composition. The flexibilizing agents employed were: glycidyloxypropyltrimethoxysilane (G PTS), methyltriethoxysilane (MTS) and dimethyldimethoxysilane (DMDMS). The results show that particularly good Taber values can be achieved with GPTS or DMDMS in an amount of about 10 wt. % or MTS in an amount of about 20 wt. %.

TABLE 5

| | | | Flexibilizing agent | | Taber |
|---|---|---|---|---|---|
| | Scratch- | | in the top layer (T) | | Abraser |
| | resistant | Top layer | | content | test |
| Layer system | layer (SR) | (T) | type | (%) | hazing (%) |
| Example 19 | Example 2 | Example 3 | GPTS | 10 | 1.5 |
| Example 20 | Example 2 | Example 3 | GPTS | 20 | 3.7 |
| Example 21 | Example 2 | Example 3 | GPTS | 30 | 3.4 |
| Example 22 | Example 2 | Example 3 | MTS | 10 | 2.3 |
| Example 23 | Example 2 | Example 3 | MTS | 5 | 2.4 |
| Example 24 | Example 2 | Example 3 | MTS | 20 | 1.3 |
| Example 25 | Example 2 | Example 3 | MTS | 30 | 2.1 |
| Example 26 | Example 2 | Example 3 | DMDMS | 5 | 4.5 |
| Example 27 | Example 2 | Example 3 | DMDMS | 10 | 2.5 |
| Example 28 | Example 2 | Example 3 | DMDMS | 20 | 3.8 |

The wetting and flow properties of the top layer coating composition on application to the scratch-resistant layer (SR) and the abrasion properties (Taber values) of the layer system resulting therefrom as a function of the amount of flow control agent contained in the top layer coating composition are shown in table 6. The results show that by using the flow control agent BYK 347 or BYK 306 in an amount of at least 0.5 wt. %, in particular 1-10 wt. %, excellent Taber values coupled with simultaneously good wetting and flow properties are achieved.

TABLE 6

| | | | Flow control | | | |
|---|---|---|---|---|---|---|
| | | | agent in the top | | | Taber |
| | Scratch- | | layer (T) | | | Abraser |
| | resistant | Top layer | | content | Wetting/ | test |
| Layer system | layer (SR) | (T) | type | (%) | flow | hazing (%) |
| Example 29 | Example 2 | Example 3 | BYK 347 | 1.0 | very good | 1.5 |
| Example 30 | Example 2 | Example 3 | BYK 347 | 0.3 | disturbances | 3.2 |
| Example 31 | Example 2 | Example 3 | BYK 347 | 5.0 | very good | 1.7 |
| Example 32 | Example 2 | Example 3 | BYK 347 | 50.0 | very good | 2.3 |
| Example 33 | Example 2 | Example 3 | BYK 306 | 1.0 | good | 1.9 |
| Example 34 | Example 2 | Example 3 | BYK 306 | 0.3 | disturbances | 2.8 |
| Example 35 | Example 2 | Example 3 | BYK 306 | 5.0 | very good | 2.1 |
| Example 36 | Example 2 | Example 3 | BYK 306 | 50.0 | very good | 2.7 |

Table 7 shows various physical properties of the layer systems as a function of the relative humidity on application of the top layer coating composition to the scratch-resistant layer (SR). The results show that a particularly good profile of properties is obtained if the application of the top layer (T) is carried out at a relative humidity of 50 to 75%, in particular 55 to 70%.

TABLE 7

| | | | Relative | | | | |
|---|---|---|---|---|---|---|---|
| | | | humidity | Hazing of | Cracking | Taber | Appear- |
| | Scratch- | | during | the scratch- | of the | Abraser | ance of |
| | resistant | Top layer | applica- | resistant | paint | test | the top |
| Layer system | layer (SR) | (T) | tion (%) | layer | layer | hazing (%) | layer |
| Example 37 | Example 2 | Example 3 | 63 | none | none | 1.5 | OK |
| Example 38 | Example 2 | Example 3 | 30 | none | slight | 14.0 | rubbed |
| | | | | | | | through |
| Example 39 | Example 2 | Example 3 | 40 | none | slight | — | partly |
| | | | | | | | rubbed |
| | | | | | | | through |
| Example 40 | Example 2 | Example 3 | 51 | none | slight | 2.7 | partly |
| | | | | | | | rubbed |
| | | | | | | | through |
| Example 41 | Example 2 | Example 3 | 73 | yes | none | n.d. | n.d. |

The wetting and flow properties of the top layer coating composition on application to the scratch-resistant layer (SR) and the abrasion properties (Taber values) of the layer systems resulting therefrom as a function of the surface treatment (activation) of the scratch-resistant layer (SR) are shown in table 8. In examples 42 and 43 the scratch-resistant layer is as example 2, cured at 130° C. for 60 minutes, and the top layer is as example 3, but with 0.3% BYK 306 as the flow control agent. The application was carried out at 23° C. and 40% relative humidity. In examples 44, 45 and 46 the scratch-resistant layer is as example 2, cured at 130° C. for 60 minutes, and the top layer is as example 3, but with 0.3% BYK 306 as the flow control agent. The application was carried out at 23° C. and 62% relative humidity. The results show that the wetting and abrasion properties are improved considerably by corona treatment or flaming of the scratch-resistant layer before application of the top layer.

TABLE 8

| | | Surface | | |
|---|---|---|---|---|
| | | tension | | |
| | | of the | | |
| | | scratch- | | |
| | Activation | resistant | Wetting | |
| | before | layer | by the | |
| | application | after | top layer | |
| Layer | of the top | activation | coating | Taber Abraser |
| system | layer | (mN/m) | composition | test hazing (%) |
| Example 42 | none | 33.6 | moderate | 8.6 top layer |
| | | | | rubbed through |
| Example 43 | by corona | 45.3 | good | 3.2 partly |
| | treatment | | | rubbed through |
| Example 44 | none | 35.7 | moderate | 7.5 top layer |
| | | | | rubbed through |
| Example 45 | single | 49.9 | good | 3.6 partly |
| | flaming | | | rubbed through |
| Example 46 | flaming twice | 64.8 | very good | 2.2 OK |

Storage Stability (Pot Life) of the Top Layer Coating Composition

The storage stability (pot life) of the top layer coating composition prepared according to example 3 by joint hydrolysis was compared with the coating sol prepared according to example 2 of the laid-open specification DE 199 52 040 A1 by separate hydrolysis. The abrasion properties (Taber values) of the layer systems prepared with the two coating compositions were furthermore compared with one another. The preparation of the scratch-resistant layer and the application were carried out according to example 5.

TABLE 9

Taber Abraser test hazing (%)

| | | Top layer | Top layer according to | |
|---|---|---|---|---|
| Storage age of | | according to | example 2 of DE 199 52 040 | |
| the sols at 4° C. | | Example 3 | A1 (comparison example) | |
| 1 | day | 1.4 | 1.6 | |
| 4 | weeks | 1.5 | 2.9 | partly rubbed through |
| 12 | weeks | 1.4 | 6.5 | rubbed through, difficult |
| | | | | coating |

The results show that the top layer coating compositions prepared by the process according to the invention have a considerably improved storage stability (pot life) compared with the top layer coating composition prepared according to DE 199 52 040 A1. The results furthermore show that layer systems with the top layer coating compositions prepared by the process according to the invention have improved abrasion properties (Taber values) compared with DE 199 52 040 A1.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process of preparing a coating composition comprising forming a hydrolysis product by hydrolysing:
(a) at lest one compound represented by general formula I,
M(R′)ₘ (I)
wherein M is an element selected from the group consisting of Si, Ti, Zr, Sn, Ce, Al, B, VO, In and Zn, R′ represents a hydrolysable radical, and m is an integer from 2 to 4; and
(b) optionally at least one compound represented by general formula II,
R_{b}SiR′ₐ, (II)
wherein the radicals R′ and R are the same or different, R′ is as defined above, R represents a group selected from an alkyl group, an alkenyl group, an aryl group, a hydrocarbon group with at least one halogen group, an epoxide group, a glycidyloxy group, an amino group, a mercapto group, a methacryloxy group and a cyano group, and a and b independently of one another have a value from 1 to 3, provided that the sum of a and b is four,
wherein the hydrolysis occurs in the presence of at least 0.6 moles of water for every mole of hydrolysable radical R′.

2. The process of claim 1 wherein the hydrolysis is carried out in the presence of 0.8 to 2.0 moles of water for every mole of hydrolysable radical R′.

3. The process of claim 1 wherein the compound of formula II is present in an amount of less than 0.7 moles, based on 1 mole of the compound of formula I.

4. The process of claim 1 wherein the hydrolysis is performed at a pH of less than 6.0.

5. The process of claim 1 wherein the solids content of the coating composition prepared is 0.2 to 20% by weight.

6. The process of claim 1 wherein the hydrolysis is performed in the presence of a solvent selected from at least one of an alcohol having a boiling point below 120° C. and water.

7. The process of claim 1 wherein M is selected from the group consisting of Si, Ti, Zr, Sn and Ce, and m is 4.

8. The process of claim 1 wherein M is selected from the group consisting of Al, B, VO and In, and m is 3.

9. The process of claim 1 wherein M is Zn, and m is 2.

10. The process of claim 1 wherein the hydrolysable radical R′ is selected from the group consisting of halogens, C₁₋₄-alkoxy, C₆₋₁₀-aryloxy, C₁₋₄-acyloxy and alkylcarbonyl.

11. The process of claim 1 wherein the compound of formula I is selected from at least one tetraalkoxysilane.

12. The process of claim 1 wherein the compound of formula II is selected from at least one of glycidyloxy-propyl-tri-methoxy-silane, methyltriethoxysilane and methacryloxy-propyl-trimethoxysilane.

13. The process of claim 1 further comprising, after completion of hydrolysis, at least one of:
adding to the hydrolysis product at least one additive selected from the group consisting of flow control agents, dyestuffs, stabilizers and inorganic fillers; and
adjusting the concentration of the hydrolysis product to 0.2 to 10 wt. % by adding at least one of alcohols, alkoxy-alcohols and water to the hydrolysis product.

14. The coating composition prepared by the process of claim 1.

15. The coating composition of claim 14 further comprising at least one flow control agent present in an amount of 0.1 to 10 wt. %.

16. A multilayered article comprising:
(a) a substrate (S);
(b) a scratch-resistant layer (SR) prepared by curing a coating composition comprising a polycondensate prepared from at least one silane having an epoxide group on a non-hydrolysable substituent, said polycondensate being prepared by a sol-gel process, said coating composition optionally further comprising at least one of particles and a curing catalyst selected from Lewis bases, titanium alcoholates, zirconium alcoholates and aluminium alcoholates; and
(c) a top layer (T) prepared by curing the coating composition of claim 14, wherein said scratch-resistant layer is interposed between said substrate and said top layer.

17. The mulilayered article of claim 16 wherein said substrate (S) comprises a plastic.

18. The mulilayered article of claim 16 wherein said scratch-resistant layer has a thickness of 0.5 to 30 μm.

19. The mulilayered article of claim 16 wherein said top layer has a thickness of 0.1 to 3.0 μm.

20. The mulilayered article of claim 16 further comprising a primer layer (P), said primer layer being interposed between said substrate and said scratch-resistant layer.

21. A process of preparing the multilayered article of claim 16 comprising the steps of:
(a) applying the scratch-resistant layer coating composition to the substrate, and curing partially the applied scratch-resistant layer coating composition under conditions such that the partially cured scratch-resistant layer comprises reactive groups;
(b) applying the top layer coating composition to the partially cured scratch-resistant layer; and
(c) curing substantially completely the partially cured scratch-resistant layer and the top layer.

22. The process of claim 21 further comprising drying the partially cured scratch-resistant layer at a temperature of greater than 110° C., prior to application of the top layer coating composition.

23. The process of claim 21 wherein the scratch-resistant layer coating composition comprises at least one flow control agent in an amount of 0.03 to 1.0 wt. %.

24. The process of claim 21 wherein the top layer coating composition is applied at a relative humidity of 50 to 75%.

25. The process of claim 21 further comprising: curing the scratch-resistant layer;
activating the surface of the cured scratch-resistant layer by treating the surface of the partially cured scratch-resistant layer with at least one of corona treatment and flame treatment; and
applying the top layer coating composition to the surface activated scratch-resistant layer.

26. The process of claim 21 further comprising applying a primer layer to the substrate prior to application of the scratch-resistant layer coating composition.
